(19) United States
(12) Patent Application Publication
(10) Pub. No.: US 2022/0084000 A1
(43) Pub. Date: Mar. 17, 2022

(54) VENDING MACHINE SENSORS

(71) Applicant: MicroEdge Technologies, Riverside, CA (US)

(72) Inventor: James Norman WINSOR, Riverside, CA (US)

(73) Assignee: MicroEdge Technologies, Riverside, CA (US)

(21) Appl. No.: 17/474,841

(22) Filed: Sep. 14, 2021

Related U.S. Application Data
(60) Provisional application No. 63/077,987, filed on Sep. 14, 2020.

(51) Int. Cl. G06Q 20/18; G01G 19/52; G01D 5/14; G07F 11/28

(52) U.S. Cl. CPC G06Q 20/18; G07F 11/28; G01D 5/14; G01G 19/52

(57) ABSTRACT

A unique programmed utility method, methodology, system and process to detect items that are physically removed from a peg hook or from inside a divider in order to charge the customer for the items removed.

### CROSS REFERENCE TO RELATED APPLICATIONS

This application claims priority to U.S. Provisional Patent Application No. 63/077,987, filed Sep. 14, 2020, which is hereby incorporated herein by reference in its entirety.

### SUMMARY

According to an embodiment, a singular apparatus in elongated peg configuration for use within an automated retail system the apparatus including:

A mounting element as means for affixing the apparatus to a surface within the automated retail system; and weight sensor, infrared sensor, sonic sensor, or sensor used to detect and sense the weight of the removal or addition of a retail products hanging; and for sale or solicitation; and the sensor or sensors information; and control electrons for means of communicating to a collecting electronic medium

The singular apparatus wherein the apparatus is mounted within a retail sales wall or retail cabinet space.

The singular apparatus arranged in a matrix, array, group of singular apparatuses.

The singular apparatus further comprising of electrical contact at or near the entrance or exit part of the elongated apparatus adding detection of retail product being removed or added from elongated apparatus.

The singular apparatus wherein the apparatus is mounted within a retail sales wall or retail cabinet space.

The singular apparatus arranged in a matrix, array, group of singular apparatuses.

A singular apparatus in elongated peg configuration for use within an automated retail system, the apparatus including:

A mounting element as means for affixing the apparatus to a surface within the automated retail system; and electrical contact sensor used to detect and sense the removal or addition of a retail products hanging; and for sale or solicitation; and the sensor information; and control electrons for means of communicating to a collecting electronic medium

The singular apparatus wherein the apparatus is mounted within a retail sales wall or retail cabinet space.

The singular apparatus arranged in a matrix, array, group of singular apparatuses.

The singular apparatus the singular apparatus of claim, wherein sensor information is communicated to the control electronics through the means of a wired communication medium.

The apparatus wherein sensor information is communicated to the control electronics through the means of a wired communication medium.

The singular apparatus the singular apparatus of claim, wherein sensor information is communicated to the control electronics through the means of a wired communication medium.

The singular apparatus, the singular apparatus of claim, wherein sensor information is communicated to the control electronics through the means of a wireless communication medium.

The apparatus wherein sensor information is communicated to the control electronics through the means of a wireless communication medium.

The singular apparatus wherein sensor information is communicated to the control electronics through the means of a wireless communication medium.

The singular apparatus wherein sensor information, control electronic and communication electronics are powered by a battery source located within the physical embodiment of the elongated apparatus.

The apparatus wherein sensor information, control electronic and communication electronics are powered by a battery source located within the physical embodiment of the elongated apparatus.

The singular apparatus wherein sensor information, control electronic and communication electronics are powered by a battery source located within the physical embodiment of the elongated apparatus.

The singular apparatus wherein the sensor; and the control electronics trigger an alarm when apparatus or has been improperly interfered; manipulated or influenced when not properly authorized.

The apparatus wherein the sensor; and the control electronics trigger an alarm when apparatus or has been improperly interfered; manipulated or influenced when not properly authorized.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

The foregoing and other features and advantages will be apparent from the following, more particular, description of various embodiments, as illustrated in the accompanying drawings,

FIG. 1 illustrates an example of some embodiments; and

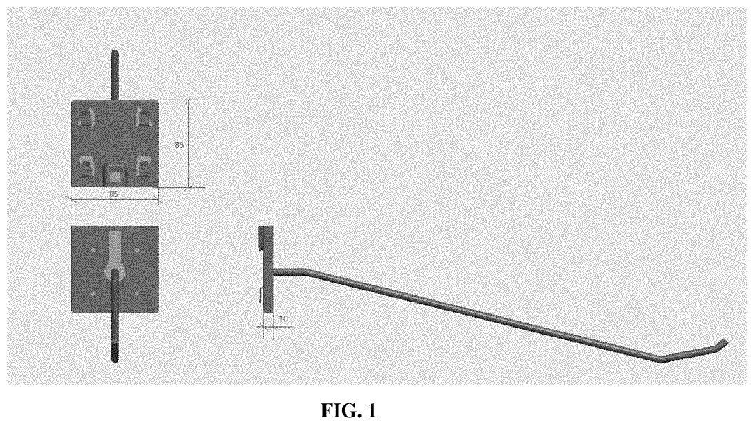

FIG. 2 conceptually illustrates an electronic system with which some embodiments of the invention are implemented.

### DETAILED DESCRIPTION

Various embodiments of the disclosure are described in detail below. While specific implementations are described, it should be understood that this is done for illustration purposes only. Other components and configurations may be used without parting from the spirit and scope of the disclosure.

In a vending style kiosk once the customer's payment is validated the kiosk door unlocks allowing customers to gain access to select their product. As products are removed from their previous position on the peg hook or divider tray a signal is sent to the control board charging the customer for the item removed by adding it to the shopping cart.

The special designed sensor peg is equipped with a contact point at the end of the shaft or weight sensors. When an item is removed the contact is broken or weight changes sending a signal that the item was removed and automatically adds the item to the shopping cart.

When products are merchandised on the shelf versus hung on a peg a special designed divider with product pusher sensors detects the movement of the product sending a signal to the control board that the item was removed and automatically adds the item to the shopping cart.

The Peg or Divider pusher sensors can be used independently or together to detect product movement or may be used in conjunction with other sensors allowing for multiple forms of validation to drive accuracy of detection. The Peg or Divider sensors may also be utilized in on open shelves, un-attended stores or micro markets in conjunction with or without other theft deterrents.

### Aspects of the Invention

A singular apparatus in elongated peg configuration for use within an automated retail system the apparatus including: mounting element as means for affixing the apparatus to a surface within the automated retail system; and weight sensor, infrared sensor, sonic sensor, or used sensor used to detect and sense the weight of the removal or addition of a retail products hanging; and for sale or solicitation; and the sensor or sensors information; and control electrons for means of communicating to a collecting electronic medium

The singular apparatus wherein the apparatus is mounted within a retail sales wall or retail cabinet space.

The singular apparatus arranged in a matrix, array, group of singular apparatuses.

The singular apparatus further comprising of electrical contact at or near the entrance or exit part of the elongated apparatus adding detection of retail product being removed or added from elongated apparatus.

The singular apparatus wherein the apparatus is mounted within a retail sales wall or retail cabinet space.

The singular apparatus arranged in a matrix, array, group of singular apparatuses.

A singular apparatus in elongated peg configuration for use within an automated retail system, the apparatus including a mounting element as means for affixing the apparatus to a surface within the automated retail system; and electrical contact sensor used to detect and sense the removal or addition of a retail products hanging; and for sale or solicitation; and the sensor information; and control electrons for means of communicating to a collecting electronic medium

The singular apparatus wherein the apparatus is mounted within a retail sales wall or retail cabinet space.

The singular apparatus arranged in a matrix, array, group of singular apparatuses.

The singular apparatus the singular apparatus of claim, wherein sensor information is communicated to the control electronics through the means of a wired communication medium.

The apparatus wherein sensor information is communicated to the control electronics through the means of a wired communication medium.

The singular apparatus the singular apparatus of claim, wherein sensor information is communicated to the control electronics through the means of a wired communication medium.

The singular apparatus the singular apparatus of claim, wherein sensor information is communicated to the control electronics through the means of a wireless communication medium.

The apparatus wherein sensor information is communicated to the control electronics through the means of a wireless communication medium.

The singular apparatus wherein sensor information is communicated to the control electronics through the means of a wireless communication medium.

The singular apparatus wherein sensor information, control electronic and communication electronics are powered by a battery source located within the physical embodiment of the elongated apparatus.

The apparatus wherein sensor information, control electronic and communication electronics are powered by a battery source located within the physical embodiment of the elongated apparatus.

The singular apparatus wherein sensor information, control electronic and communication electronics are powered by a battery source located within the physical embodiment of the elongated apparatus.

The singular apparatus wherein the sensor; and the control electronics trigger an alarm when apparatus or has been improperly interfered; manipulated or influenced when not properly authorized.

The apparatus wherein the sensor; and the control electronics trigger an alarm when apparatus or has been improperly interfered; manipulated or influenced when not properly authorized.

The singular apparatus wherein the sensor; and the control electronics trigger an alarm when apparatus or has been improperly interfered; manipulated or influenced when not properly authorized.

The singular apparatus wherein the sensor; and the control electronics trigger an illuminating devise when apparatus when a product has been removed or added to the apparatus.

The apparatus wherein the sensor; and the control electronics trigger an illuminating devise when apparatus when a product has been removed or added to the apparatus.

The singular apparatus wherein the sensor; and the control electronics trigger an illuminating devise when apparatus when a product has been removed or added to the apparatus.

The singular apparatus wherein the apparatus is queried to provide product inventory.

The apparatus wherein the apparatus is queried to provide product inventory.

The singular apparatus wherein the apparatus is queried to provide product inventory.

The singular apparatus wherein the apparatus provides specific self-identification.

The apparatus wherein the apparatus provides specific self-identification.

The singular apparatus wherein the apparatus provides specific self-identification.

The singular apparatus wherein the apparatus is queried to provide product inventory.

The singular apparatus wherein the apparatus is equipped with a devise to automatically move product to the furthest front-end of the apparatus.

The singular apparatus wherein the apparatus is equipped with a devise to automatically move product to the furthest front-end of the apparatus.

The singular apparatus wherein the apparatus is equipped with a devise to automatically move product to the furthest front-end of the apparatus.

The singular apparatus wherein the apparatus is place at a sufficient angle to automatically move product by means of gravity to the furthest front-end of the apparatus.

The singular apparatus wherein the apparatus is place at a sufficient angle to automatically move product by means of gravity to the furthest front-end of the apparatus.

The singular apparatus wherein the apparatus is place at a sufficient angle to automatically move product by means of gravity to the furthest front-end of the apparatus.

A multiple apparatus in elongated peg configuration for use within an automated retail system, the apparatus including a mounting element as means for affixing the apparatus to a surface within the automated retail system; and weight sensor used to detect and sense the weight of the removal or addition of a retail products hanging; and for sale or solicitation; and the sensor or sensors information; and control electrons for means of communicating to a collecting electronic medium.

Embodiments of the invention may also include:

Wireless communication such as blue tooth, NFC, 27 Mhz, infrared or other wireless means of communication;

Battery powered for wireless communication;

Dual or multiple pegs for heavy objects;

By weight or by object of different weight but on same peg;

Pusher spring for advancing product;

Laser integrated on base;

Pegs can either be level or angled for automatic facing—moving product to from of peg;

“U” type of formation at entrance point of peg to hold product when peg is on an angle;

Display on base showing product count in real time;

Multi color LED as base plate for indication of inventory levels;

Different sensor sensitivity for range of light to heavy products.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

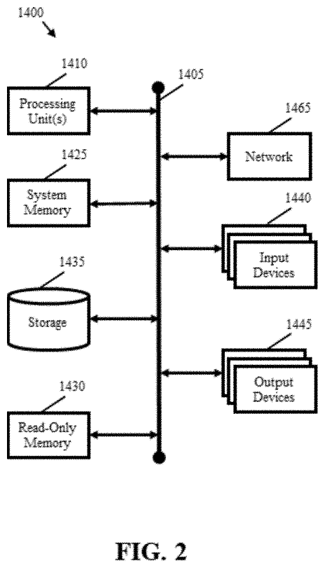

FIG. 2 conceptually illustrates an electronic system 1400 with which some embodiments of the invention are implemented. The electronic system 1400 can be used to execute any of the control and/or compiler systems described above in some embodiments. The electronic system 1400 may be a computer (e.g., a desktop computer, personal computer, tablet computer, server computer, mainframe, a blade computer etc.), phone, PDA, or any other sort of electronic device. Such an electronic system includes various types of computer readable media and interfaces for various other types of computer readable media. Electronic system 1400 includes a bus 1405, processing unit(s) 1410, a system memory 1425, a read-only memory 1430, a permanent storage device 1435, input devices 1440, and output devices 1445.

The bus 1405 collectively represents all system, peripheral, and chipset buses that communicatively connect the numerous internal devices of the electronic system 1400. For instance, the bus 1405 communicatively connects the processing unit(s) 1410 with the read-only memory 1430, the system memory 1425, and the permanent storage device 1435.

From these various memory units, the processing unit(s) 1410 retrieves instructions to execute and data to process in order to execute the processes of the invention. The processing unit(s) may be a single processor or a multi-core processor in different embodiments.

The read-only-memory 1430 stores static data and instructions that are needed by the processing unit(s) 1410 and other modules of the electronic system. The permanent storage device 1435, on the other hand, is a read-and-write memory device. This device is a non-volatile memory unit that stores instructions and data even when the electronic system 1400 is off. Some embodiments of the invention use a mass-storage device (such as a magnetic or optical disk and its corresponding disk drive) as the permanent storage device 1435.

Other embodiments use a removable storage device (such as a floppy disk, flash drive, etc.) as the permanent storage device. Like the permanent storage device 1435, the system memory 1425 is a read-and-write memory device. However, unlike storage device 1435, the system memory is a volatile read-and-write memory, such a random-access memory. The system memory stores some of the instructions and data that the processor needs at runtime. In some embodiments, the invention's processes are stored in the system memory 1425, the permanent storage device 1435, and/or the read-only memory 1430. From these various memory units, the processing unit(s) 1410 retrieves instructions to execute and data to process in order to execute the processes of some embodiments.

The bus 1405 also connects to the input devices 1440 and output devices 1445. The input devices enable the user to communicate information and select commands to the electronic system. The input devices 1440 include alphanumeric keyboards and pointing devices (also called “cursor control devices”). The output devices 1445 display images generated by the electronic system. The output devices include printers and display devices, such as cathode ray tubes (CRT) or liquid crystal displays (LCD). Some embodiments include devices such as a touchscreen that function as both input and output devices.

Finally, as shown in FIG. 2, bus 1405 also couples electronic system 1400 to a network 1465 through a network adapter (not shown). In this manner, the computer can be a part of a network of computers (such as a local area network (“LAN”), a wide area network (“WAN”), or an Intranet, or a network of networks, such as the Internet. Any or all components of electronic system 1400 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

1. A singular apparatus in elongated peg configuration for use within an automated retail system the apparatus including:
a mounting element as means for affixing the apparatus to a surface within the automated retail system; and weight sensor, infrared sensor, sonic sensor, or sensor used to detect and sense the weight of the removal or addition of a retail products hanging; and for sale or solicitation; and the sensor or sensors information; and control electrons for means of communicating to a collecting electronic medium.

2. The singular apparatus of claim 1, wherein the apparatus is mounted within a retail sales wall or retail cabinet space.

3. The singular apparatus of claim 1 arranged in a matrix, array, group of singular apparatuses.

4. The singular apparatus of claim 1, further comprising of electrical contact at or near the entrance or exit part of the elongated apparatus adding detection of retail product being removed or added from elongated apparatus.

5. The singular apparatus of claim 3 wherein the apparatus is mounted within a retail sales wall or retail cabinet space.

6. The singular apparatus of claim 3 arranged in a matrix, array, group of singular apparatuses.

7. A singular apparatus in elongated peg configuration for use within an automated retail system, the apparatus including:
a mounting element as means for affixing the apparatus to a surface within the automated retail system; and electrical contact sensor used to detect and sense the removal or addition of a retail products hanging; and for sale or solicitation; and the sensor information; and control electrons for means of communicating to a collecting electronic medium.

8. The singular apparatus of claim 7, wherein the apparatus is mounted within a retail sales wall or retail cabinet space.

9. The singular apparatus of claim 7, arranged in a matrix, array, group of singular apparatuses.

10. The singular apparatus of claim 1, the singular apparatus of claim, wherein sensor information is communicated to the control electronics through the means of a wired communication medium.

11. The apparatus of claim 4, wherein sensor information is communicated to the control electronics through the means of a wired communication medium.

12. The singular apparatus of claim 7, the singular apparatus of claim, wherein sensor information is communicated to the control electronics through the means of a wired communication medium.

13. The singular apparatus of claim 1, the singular apparatus of claim, wherein sensor information is communicated to the control electronics through the means of a wireless communication medium.

14. The apparatus of claim 4, wherein sensor information is communicated to the control electronics through the means of a wireless communication medium.

15. The singular apparatus of claim 7, the singular apparatus of claim, wherein sensor information is communicated to the control electronics through the means of a wireless communication medium.

16. The singular apparatus of claim 1, wherein sensor information, control electronic and communication electronics are powered by a battery source located within the physical embodiment of the elongated apparatus.

17. The apparatus of claim 4, wherein sensor information, control electronic and communication electronics are powered by a battery source located within the physical embodiment of the elongated apparatus.

18. The singular apparatus of claim 7, wherein sensor information, control electronic and communication electronics are powered by a battery source located within the physical embodiment of the elongated apparatus.

19. The singular apparatus of claim 1, wherein the sensor; and the control electronics trigger an alarm when apparatus or has been improperly interfered; manipulated or influenced when not properly authorized.

20. The apparatus of claim 4, wherein the sensor; and the control electronics trigger an alarm when apparatus or has been improperly interfered; manipulated or influenced when not properly authorized.
